(19) United States
(12) Patent Application Publication
(10) Pub. No.: US 2023/0010440 A1
(43) Pub. Date: Jan. 12, 2023

(54) System and Method for Performing Identity Management

(71) Applicant: Pelion IoT Limited, Glasgow (GB)

(72) Inventors: Alan` Christopher Tait, Glasgow (GB); Niall Graham Strachan, Bearsden (GB)

(73) Assignee: Pelion IoT Limited, Glasgow (GB)

(21) Appl. No.: 17/772,828

(22) PCT Filed: Mar. 20, 2020
(86) PCT No.: PCT/GB2020/050744

§ 371 Date: Apr. 28, 2022

(30) Foreign Application Priority Data
Oct. 30, 2019 (GB) 1915723.9

(51) Int. Cl. H04W 12/06

(52) U.S. Cl. CPC H04W 12/06

(57) ABSTRACT

A method of verifying an identity of a wireless device. The method comprising receiving a calling station identity from a SIM of a wireless device, receiving a secure identifier derived by a secure element of the wireless device, comparing the received calling station identity to calling station identities of authorized wireless devices to identify obtain a corresponding wireless device identity, confirming whether the secure identifier is authentic and determining a second wireless device identity from the secure identifier, and comparing the first wireless device identity and the second wireless device identity to verify the identity of the wireless device.

The present application relates to a system and method performing identity management, and in particular for performing identity management over a cellular telecommunications network.

### BACKGROUND

It is generally desirable to be able to confirm the identity of a wireless device attempting to access services through a cellular telecommunications network in order to ensure correct billing of customers and to control access to network resources, to prevent possible illicit and unauthorized use of those network resources. This desire has been reinforced by increasing interest in wireless connected devices with wireless data connections, for example, for use as communication channels for the automatic reporting of data by the devices and sending of data and instructions to the devices. Such wireless connected devices and their connectivity are commonly referred to as the Internet of Things (IoT), and may also be referred to as machine to machine (M2M) communication.

It is common for devices carrying out IoT/M2M communication to be allowed access to network resources such as private corporate resources, or device management or application services. It is generally intended that only known/authorized users using known/authorized devices should be allowed access to such network resources and it is usually undesirable for other users and devices to be allowed access.

Conventionally, access to online resources has been managed based on one or both of the International Mobile Subscriber Identity (IMSI) and Mobile Subscriber Integrated Services Digital Network Number (MSISDN) provided through a communications network by the device requesting access to the network resources. A problem with this approach is that the IMSI and MSISDN are associated with the SIM enabling wireless operation of a device, and not with the device itself, so that if the SIM is in any device it can be configured to connect that device to the network resources.

The embodiments described below are not limited to implementations which solve any or all of the disadvantages of the approaches described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, the present disclosure provides a method of verifying an identity of a wireless device, the method comprising: receiving a calling station identity from a SIM of a wireless device; receiving a secure identifier derived by a secure element of the wireless device; comparing the received calling station identity to calling station identities of authorized wireless devices to obtain a corresponding wireless device identity; confirming whether the secure identifier is authentic and determining a second wireless device identity from the secure identifier; comparing the first wireless device identity and the second wireless device identity to verify the identity of the wireless device.

In a second aspect, the present disclosure provides a method of controlling access to a resource, the method comprising: verifying the identity of a wireless device using the method of the first aspect; and if the identity of the wireless device is verified, allowing the wireless device to access a resource; or if the identity of the wireless device is not verified, not allowing the wireless device to access the resource.

In a third aspect, the present disclosure provides a system for verifying the identity of a wireless device, the system comprising: means arranged to receive a calling station identity from a SIM of a wireless device; means arranged to receive a secure identifier derived by a secure element of the wireless device; means arranged to compare the received calling station identity to calling station identities of authorized wireless devices to obtain a corresponding wireless device identity; means arranged to confirm whether the secure identifier is authentic and determining a second wireless device identity from the secure identifier; means arranged to compare the first wireless device identity and the second wireless device identity to verify the identity of the wireless device.

In a fourth aspect, the present disclosure provides a system for controlling access to a resource, the system comprising: a system arranged to verifying the identity of a wireless device according to the third aspect; and further comprising means arranged to: if the identity of the wireless device is verified, allow the wireless device to access a resource; or if the identity of the wireless device is not verified, not allowing the wireless device to access the resource.

The methods described herein may be performed at least in part by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the disclosure.

### BRIEF DESCRIPTION OF THE DRAWINGS

Embodiments of the invention will be described, by way of example, with reference to the following drawings, in which:

FIG. 1 is an explanatory diagram of a system for data transmission according to a first embodiment;

FIG. 2 is an explanatory diagram of a method useable by the system of FIG. 1 in the first embodiment;

FIG. 3 is an explanatory diagram of a method useable by the system of FIG. 1 in a second embodiment; and

FIG. 4 is an explanatory diagram of a method useable by the system of FIG. 1 in a third embodiment.

Common reference numerals are used throughout the figures to indicate similar features.

### DETAILED DESCRIPTION

Embodiments are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

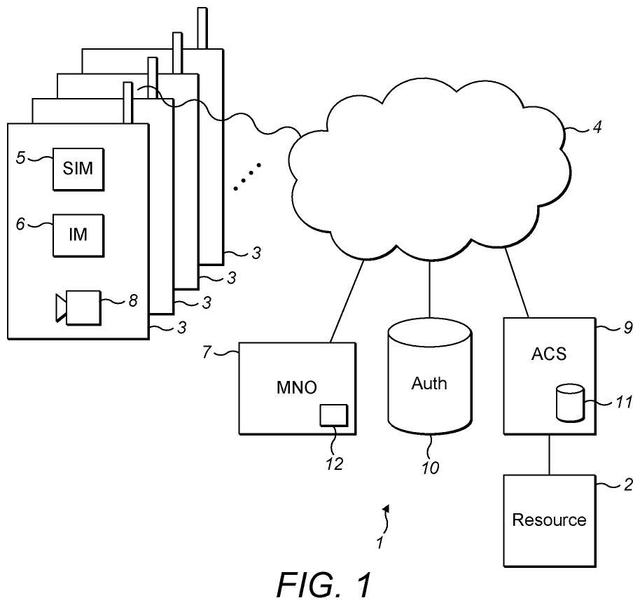

FIG. 1 shows a diagrammatic illustration of an access control system 1 arranged to verify the identity a number of wireless connected devices 3, and to control access to a network resource 2 by the wireless connected devices 3 based on the identity verification.

As shown in FIG. 1, a number of wireless connected devices 3 are arranged for wireless connection to a wireless communications network 4 to enable communication by the wireless connected devices 3 through the wireless communications network 4. A network resource 2 is also connected to the wireless communication network 4, whereby authorized ones of the wireless connected devices 3 are able to access the network resource 2 through the wireless communications network 4. The wireless communications network 4 is operated by a mobile network operator (MNO) 7.

In the illustrated example the wireless connected devices are wireless communication devices and the wireless communication network is a cellular communications network. In other examples different types of devices and communications network may be used.

The wireless connected devices 3 may, for example, be devices arranged to provide Internet of Things (IoT) functionality or machine to machine (M2M) functionality. Accordingly, the wireless connected devices 3 may be referred to as an IoT devices or M2M devices.

A single wireless communications network 4 operated by a single MNO 7 is shown in FIG. 1 for simplicity and clarity. In practice there may be a number of different wireless communication networks 4 operated by a number of MNOs 7, and possibly a large number of such different wireless communication networks 4. The wireless connected devices 3 and the network resource 2 may be connected to different interconnected wireless communication networks 4, which may be operated by different MNOs 7. Further, the different wireless communication networks 4 to which the wireless connected devices 3 and the network resource 2 are connected may be interconnected by one or more further wireless communication networks 4.

In order to provide wireless connectivity, each of the wireless connected devices 3 comprises a SIM 5. Each wireless connected device 3 also comprises an identification module 6, which will be described in more detail below. The wireless connected devices 3 can, in principle, be any type of device or object. In examples where the wireless connected devices 3 are IoT or M2M devices the wireless connected devices 3 may comprise one or more sensors 8.

In the illustrated example the SIM 5 is an Embedded Universal Integrated Circuit Card (eUICC) enabled SIM, commonly referred to as an eSIM, which allows different eSIM profiles to be remotely provisioned over the air to the eSIM. These different eSIM profiles can then be used by the eSIM for communication with wireless communications networks, such as the wireless communications network 4. Different eSIM profiles may be activated and used on the SIM 5 by the wireless connected device 3 as required to support the wireless communications functionality required by the wireless connected device 3. For example, different eSIM profiles may be activated and used by the SIM 5 when the wireless connected device 3 is in different locations, in order to enable communication with an appropriate one of the different wireless communications networks 4 providing wireless connectivity coverage at the location of the wireless connected device 3. As another example, alternatively or additionally, different eSIM profiles may be activated and used by the SIM 5 when the wireless connected device 3 requires different communications functionality to support different activities in order to enable communication with an appropriate one of the different wireless communications networks 4 providing the required communications functionality, or providing the required communications functionality on preferred terms, such as a cheaper tariff. In the present application the term “eSIM” is used to refer to the eUICC enabled SIM, it should be noted that the term “eSIM” is also sometimes instead used to refer to the eSIM profiles.

The use of an eSIM as the SIM 5 is not essential. The SIM 5 may be any type of SIM. In alternative examples the SIM 5 may be a physical SIM card or a iSIM. An iSIM is provided by software run on a dedicated secure enclave of a system-on-chip (SoC) which enables eSIM profiles to be supported by, and remotely provisioned over the air to, an SoC processor having the necessary capabilities and functionality to support the operation of the eSIM profiles.

The identification module 6 is a secure element comprising physical components forming a physical part of the wireless connected device 3. For example, the identification module 6 may be an element soldered to a circuit board within the wireless connected device 3. In some examples the identification module 6 may be arranged so that it is difficult or impossible to remove the identification module 6 from the wireless connected device 3 without destroying or damaging the identification module 6 so that it is no longer functional. In some examples where the SIM 5 is an iSIM the identification module 6 may be combined with, or a part of, a secure element that holds eUICC profiles. In other examples, the identification module 6 may be separate from any secure element that holds eUICC profiles.

The identification module 6 is arranged to be able to generate or derive a secure identifier which can be used to confirm the identity of the identification module 6, and so confirm the identity of the wireless connected device 3 in which the identification module 6 is comprised, or to which the identification module 6 is attached. The form of the secure identifier and the precise functionality of the identification module 6 will depend on the method of confirming identity which is used in any specific implementation, and some specific exemplary embodiments will be discussed below. In the illustrated embodiment of FIG. 1 the identification module 6 is arranged to generate or derive a secure identifier that is unique to the specific identification module 6, and thus unique to the wireless connected device 3 to which the identification module 6 is attached.

The identification module 6 may be a physical cryptography device. The identification module 6 may, for example, generate a one time pad (OTP) value, or an RSA key, or may be arranged to generate a known response to a specific challenge, for example by the use of one or more private cryptographic keys. These examples are not intended to be exhaustive.

The access control system 1 comprises an authentication and access control service 9 and an authorization server 10. The access control service 9 is arranged to verify the identity of wireless connected devices 2 requesting access to the network resource 2 through the wireless communications network 4, and to control access by the wireless connected devices 2 to the network resource 2 based upon the results of this verification. The authorization server 10 is arranged to confirm the authenticity of identifiers provided to the access control service 9 by the identification modules 6 of the wireless connected devices 3.

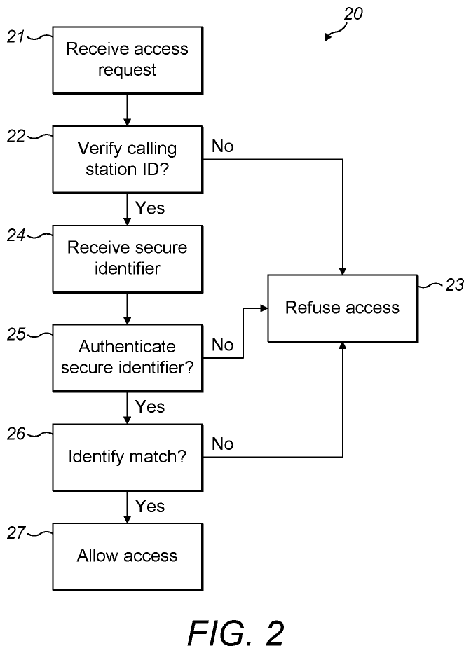

A flowchart showing an overview of an access control method 20 according to a first embodiment which may be carried out by the system 1 is shown in FIG. 2.

As shown in FIG. 2, the method 20 begins when the access control service 9 receives a request for access to the network resource 2 from a wireless connected device 3 through the wireless communications network 4 in a receive access request block 21. The request for access includes, or is received together with, the calling station identity (calling-station-id) used by the wireless connected device 3 to make the request for access.

The calling-station-id is a device identifier used by the wireless connected device 3. In the illustrated example the wireless connected device 3 is communicating through the wireless network 4 and the calling-station-id is the device identifier used by the wireless connected device 3 to identify itself to the wireless network 4. In some examples the calling-station-id is the International Mobile Subscriber Identity (IMSI) or the Mobile Subscriber Integrated Services Digital Network Number (MSISDN) of the SIM 5 used by the wireless connected device 3 to send the request, however other types of calling-station-id may be used in other examples. In some examples the calling-station-id can be a MAC address, or similar. In some examples the calling-station-id may be a network specific identifier of a mobile terminal or mobile equipment (ME) comprising the wireless connected device 3.

Then, the access control service 9 verifies that the calling-station-id used by the wireless connected device 3 to make the request for access is an authorized calling-station-id, that is, a calling-station-id associated with a wireless connected device 3 authorized to access the network resource 2, in a verify calling-station-id block 22.

The access control service 9 comprises a data store 11 containing a database mapping all possible calling-station-ids which may be used by devices 3 which are authorized to access the network resource 2 to the specific wireless connected devices 3. As is explained above, the possible calling-station-ids may be the MSISDN of each profile installed on the SIMs 5 of devices 3 which are authorized to access the network resource 2. The MSISDN of the profile in use may be mapped to the ICCID of a specific wireless connected device 3 and customer by a connectivity management system associated or combined with the access control service 9. In some examples, the access control service 9 may maintain and update the mapping in the database based on information provided by the entity provisioning eSIM profiles to the eSIMs of the wireless connected devices 3.

In some examples where a number of different calling-station-ids are associated with a number of different profiles which are available to be installed onto different wireless connected devices 3, the mapping may only associate the “pool” or group of calling-station-ids available to each wireless connected device 3 to the specific wireless connected devices 3 without any mapping or determination which of the available calling-station-ids of the pool are currently installed on each wireless connected device 3.

The MSISDN used by a eSIM profile as a calling-station-id will vary depending upon the identity of the MNO operating the wireless communication network which the eSIM profile is using to make the call. Accordingly, in examples where the calling-station-id is an MSISDN, the database of authorized calling station identifiers includes data identifying all possible MSISDNs which may be used by eSIM profiles which are installed on the SIMs 5 of each device 3 authorized to access the network resource 2. In an example this data may identify all possible MSISDNs of all profiles installed on the SIMs 5 of authorized devices 3, together with data mapping the possible MSISDNs to authorized devices 3. In other examples, this data may be in another form, such as data identifying all profiles (for example by the IMSIs of the profiles) installed on the SIMs 5 of authorized devices 3 and the MNOs 7 which the profiles are able to communicate with, so that all possible MSISDNs may be determined from the data, together with data mapping the profiles to the authorized devices 3.

In the verify calling-station-id block 22 the access control service 9 compares the calling-station-id used by the wireless connected device 3 to make the request for access to the database in the data store 11 and confirms whether or not this calling-station-id maps to an authorized wireless connected device 3.

If the access control service 9 determines that the calling-station-id does not map to an authorized wireless connected device 3 the request to access the network resource 2 is refused in a refuse access request block 23.

If the access control service 9 determines that the calling-station-id does map to an authorized wireless connected device 3, the method 20 continues by the authorization server 10 receiving a secure identifier generated by the identification module 6 of the wireless connected device 3 making the request for access in a receive identifier block 24.

In some examples the secure identifier may be included in, or sent together with, the request for access to the network resource 2 from the wireless connected device 3 which is received by the access control service 9, and the secure identifier may be forwarded to the authorization server 10 by the access control service 9 together with the identity of the wireless connected device which was mapped to by the calling-station-id. In some examples the secure identifier may be sent directly to the authorization server 10 by the wireless connected device 3, while the identity of the wireless connected device which was mapped to by the calling-station-id is sent separately to the authorization server 10 by the access control service 9. In some examples the secure identifier may be generated by the identification module 6 of the wireless connected device 3 in response to a challenge sent to the wireless connected device by the access control service 9 or the authorization server 10.

Then, the authorization server 10 verifies that the secure identifier provided by the wireless connected device 3 is an authentic secure identifier, that is, a secure identifier associated with the identification module 6 of a wireless connected device 3 authorized to access the network resource 2, in an authenticate secure identifier step 25.

The authorization server 10 comprises a security mechanism 12 arranged to confirm whether a secure identifier is an authentic secure identifier generated by the identification module 6 of an authorized wireless connected device 3, and if so, to determine the identity of that authorized wireless connected device 3. The precise functionality of the security mechanism 12 will depend on the method of confirming identity which is used in any specific implementation, and some specific exemplary embodiments will be discussed below. The security mechanism 12 may be a cryptography device. The security mechanism 12 may, for example, be able to verify the correctness of a one time pad (OTP) value, or an RSA key, of a received identifier, or may be arranged to verify the correctness of a response to a specific challenge, which response is included in the received secure identifier, and to identify which wireless connected device is associated with the received identifier. These examples are not intended to be exhaustive. In some examples the authorization server 10 may be part of a connectivity management system holding credentials which the secure identifiers are compared to.

If the authorization server 10 determines that the secure identifier is not authentic, that is that the secure identifier has not been confirmed as being received from the identification module 6 of an authorized wireless connected device 3, the request for access to the network resource 2 is refused in the refuse access request block 23.

If the authorization server 10 determines that the secure identifier is authentic, that is, that the secure identifier has been authenticated as being received from an identification module 6 of an authorized wireless connected device 3, the authorization server 10 confirms authentication of the secure identifier and the identity of that specific wireless connected device 3 to the access control service 9. The access control service 9 then compares the identity of the authorized wireless connected device 3 which was mapped to by the calling-station-id and the identity of the authorized wireless connected device 3 provided by the authorization server 10 to determine whether the two authorized device identities match in an identity match block 26.

If the access control service 9 determines that the two device identities do not match, the request for access to the network resource 2 is refused in the refuse access request block 23.

If the access control service 9 determines that the two device identities do match, the access control service 9 allows the wireless connected device 3 to access the network resource 2 in an allow access block 27.

Accordingly, the system 1 and method 20 according to the first embodiment verify the identity of a wireless connected device 3 which provides a calling-station-id which is verified by the access control service 9, and also provides a secure identifier which is authenticated by the authorization server 10, by confirming that the verified calling-station-id and the authenticated secure identifier match, that is, are both associated with the same specific device. This provides two factor identification of wireless connected devices 3, with the first factor being the calling-station-id used, which is associated with the eSIM profile used by the wireless connected device 3, and the second factor being the secure identifier, which is associated with the identification module 6 of the wireless connected device 3.

Further, the system 1 and method 20 according to the first embodiment only permit access to the network resource 2 by wireless connected devices 3 which have had their identity verified. Accordingly, the present disclosure may provide improved security preventing access by unauthorized devices to the network resource. This improved security may be provided even if unauthorized devices use a SIM taken from an authorized device, or an eSIM profile copied from an authorized device, or otherwise present a falsified calling-station-id, such as an International Mobile Equipment Identity (IMEI) number copied from an authorized device.

The first embodiment discussed above uses an identification module 6 which is arranged to generate a secure identifier that is unique to the specific identification module 6. However, this is not essential. Provided that the number of possible different secure identifiers is sufficiently large it may not be necessary to use unique secure identifiers in order to confirm device identity with sufficient certainty to provide an acceptable level of security, as is well understood by the skilled person in the field of security. In examples where non-unique secure identifiers are used the verified calling-station-id and the authenticated secure identifier may be regarded as matching, and access to the network resource may be permitted, when the device associated with the verified calling-station-id corresponds to one of the devices associated with the authenticated secure identifier.

In the first embodiment discussed above the access control service 9 confirms whether the secure identifier is authentic, that is, that the secure identifier has been authenticated as being received from the identification module 6 of the same specific wireless connected device 3 which was identified as being mapped to by the calling-station-id. In alternative examples the authorization server 10 may confirm that the secure identifier is authentic. In such examples the access control service 9 may send the identity of the specific wireless connected device 3 mapped to by the calling-station-id to the authorization server 10 in addition to the secure identifier, and the authorization server 10 can then determine whether the secure identifier has been authenticated as being received from the identification module 6 of the same specific wireless connected device 3 which was identified as being mapped to by the calling-station-id, and accordingly whether the request for access to the network resource 2 should be refused or allowed.

In further alternative examples the authorization server 10 may confirm only that the secure identifier has been authenticated as being received from an identification module 6 of a specific wireless connected device 3. Confirmation of authentication from the authorization server 10, together with the identity of the specific wireless connected device 3, and the determination that the calling-station-id does map to an authorized wireless connected device 3 from the access control service 9, together with the identity of the authorized wireless connected device 3, can be sent to a separate device which can then determine whether the secure identifier has been authenticated as being received from the identification module 6 of the same specific wireless connected device 3 which was identified as being mapped to by the calling-station-id, and accordingly whether the request for access to the network resource 2 should be refused or allowed.

In some examples the access control service 9 may be operated by an access management entity controlling access to the network resources 2, while the authorization server 10 is operated by a separate identity management service.

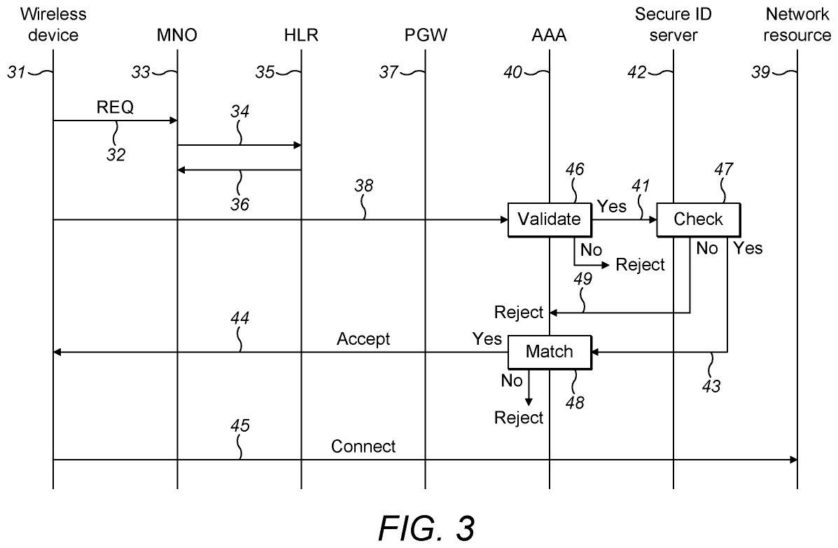

An example of a specific access control method 30 according to a second embodiment is shown in a schematic call flow diagram in FIG. 3.

In the second embodiment a wireless connected device 31 is connected for communication to a wireless communications network. The wireless connected device 31 may attach to a home wireless communications network of an eSIM profile of an eUICC of the wireless connected device 31 by sending an attachment request 32 to a mobile network operator (MNO) 33 of the home wireless communications network. The MNO 33 then sends a query 34 to a Home Location Register (HLR) 35 of the MNO 33 to confirm whether the profile is authorized to use the wireless communications network. If the HLR 35 returns confirmation 36 that the profile is authorized, the MNO 33 allows the wireless connected device 31 to connect to the wireless communications network. In this example a conventional method of attaching a wireless device to a wireless communications network is used. In other examples alternative attachment methods may be used.

The wireless connected device 31 then sends to a Packet GateWay (PGW) 37 a request 38 for Packet Data Protocol (PDP) access to a network resource 39. The request 38 includes a One Time Password (OTP) generated by an identification module of the wireless connected device 31, and a response to the OTP generated by the identification module from the OTP, for example by using a private cryptographic key stored in the identification module.

The PGW 37 forwards the request 38 to an Authentication, Access and Accounting (AAA) server 40, arranged to provide an access control service controlling access to the network resource 39. The AAA server 40 may operate similarly to the access control service 9 of the first embodiment.

The HLR 35 and the PGW 37 of the second embodiment correspond to elements of the wireless communications network 4 of the first embodiment, which is described in less detail. The AAA server 40 of the second embodiment provides corresponding functionality to the ACS 9 of the first embodiment.

The AAA server 40 carries out a validation 46 of the calling-station-id used by the wireless connected device 31 to attach to the wireless communications network and send the request 38. In this example the calling-station-id is the MSISDN. Similarly to the operation of the access control service 9 of the first embodiment described above, the AAA server 40 carries out a validation which determines whether or not the calling-station-id used by the wireless connected device 31 is an authorized calling-station-id, that is, a calling-station-id which maps to a wireless connected device authorized to access the network resource 39, and, if the calling-station-id is an authorized calling-station-id, the identity of this associated authorized wireless connected device.

If the AAA server 40 determines that the calling-station-id does not map to an authorized device 31 the AAA server 40 refuses the request to access the network resource 39.

If the AAA server 40 determines that the calling-station-id does map to an authorized device 31, the AAA server 40 sends an identity confirmation request 41 to a secure ID server 42. The identity confirmation request 41 comprises the OTP and response provided by the wireless connected device 31 in the request 38 formatted as a username and password respectively.

The secure ID server 42 checks 47 whether the provided OTP and response are a valid username and password pair, and if they are a valid username and password pair, the identity of wireless connected device that they relate to. This check may be carried out in any convenient manner. A number of such check methods are known in the field of secure identity checking and access control. The secure ID server 42 of the second embodiment provides corresponding functionality to the ACS 9 and authentication server 10 of the first embodiment.

The secure ID server 42 sends a reply back to the AAA server 40 indicating whether or not the provided OTP and response are a valid username and password pair. Further, if the provided OTP and response are a valid username and password pair the secure ID server 42 also sends a device identity token indicating the identity of the wireless connected device 31 corresponding to that username and password pair together with, or as a part of, the reply.

If the reply is a reply 49 indicating that the provided OTP and response are not a valid username and password pair, the AAA server 40 refuses the request to access the network resource 39.

If the reply is a reply 43 indicating that the provided OTP and response are a valid username and password pair, the AAA server 40 checks 48 whether or not the identity of the wireless connected device 31 according to the device identity token corresponds to the identity of the authorized wireless connected device identified by the mapping by the AAA server 40.

If the AAA server 40 determines that the identity of the wireless connected device 31 according to the device identity token does not correspond to the identity of the authorized wireless connected device identified by the mapping, the AAA server 40 refuses the request to access the network resource 39. Alternatively, if the AAA server 40 determines that the identity of the wireless connected device 31 according to the device identity token does correspond to the identity of the authorized wireless connected device identified by the mapping, the AAA server 40 accepts the request to access the network resource 39, and sends an acceptance message 44 to the wireless connected device 31.

The wireless connected device 31 then sets up a PDP connection 45 to the network resource 39, as permitted by the AAA server 40.

In the example of the second embodiment described above the AAA server 40 carries out a validation which determines whether or not the calling-station-id used by the wireless connected device 31 is an authorized calling-station-id, that is, a calling-station-id which maps to a wireless connected device authorized to access the network resource 39, and, if the calling-station-id is an authorized calling-station-id, the identity of this associated authorized wireless connected device. Similarly to the first embodiment, in other examples where a number of different calling-station-ids are associated with a number of different profiles which are available to be installed onto different wireless connected devices 31, the mapping may only associate the “pool” or group of calling-station-ids available to each wireless connected device 31 to the specific wireless connected devices 31 without any mapping or determination which of the available calling-station-ids of the pool are currently installed on each wireless connected device 31.

Accordingly, the method 30 according to the illustrated second embodiment verifies the identity of a wireless connected device 31 which provides a calling-station-id which is verified by the AAA server 40, and also provides a secure identifier which is authenticated by the secure ID server 42, by confirming that the verified calling-station-id and the authenticated secure identifier match, that is, are both associated with the same specific device 31. This provides two factor identification of the wireless connected device 31, with the first factor being the calling-station-id used, which is associated with the eSIM profile used by the wireless connected device 31, and the second factor being the secure identifier, which is associated with the identification module of the wireless connected device 31. Further, the method 30 according to the second embodiment only permits access to the network resource 39 by wireless connected devices 31 which have had their identity verified. Accordingly, the present disclosure may provide improved security preventing access by unauthorized devices to the network resource.

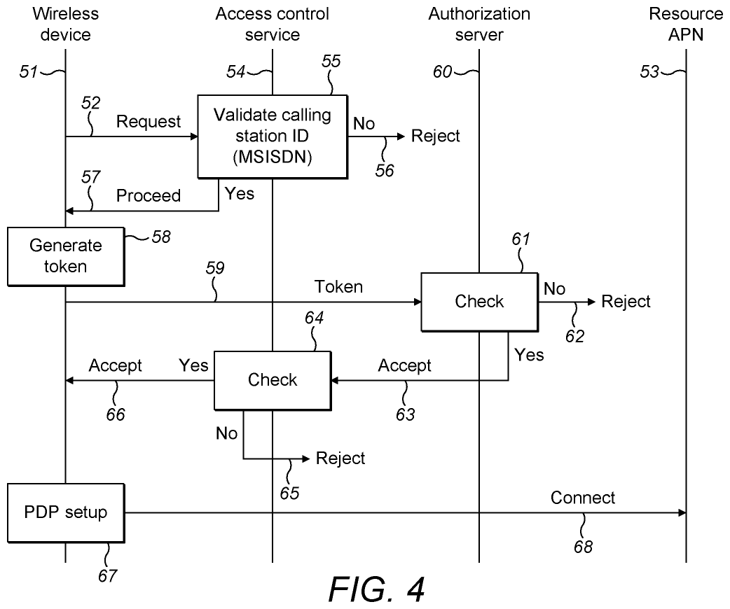

An example of a specific access control method 50 according to a third embodiment is shown in a schematic call flow diagram in FIG. 4.

In the second embodiment a wireless connected device 51 is connected for communication to a wireless communications network. The wireless connected device 31 may attach to the home wireless communications network of an eSIM profile of the wireless connected device 51 in a similar manner to that described above with reference to the second embodiment, or in some other manner. The wireless connected device 51 may be similar to the wireless connected device 3 of the first embodiment.

The wireless connected device 51 then sends a request 52 for Packet Data Protocol (PDP) access to a network resource 53, in this example by using an Access Point Name (APN) of the network resource.

The request 52 is received by an access control service 54, which may be part of an Authentication, Access and Accounting (AAA) server, controlling access to the network resource 53. The access control service 54 may be similar to the access control service 9 of the first embodiment.

The access control service 54 carries out a validation 55 of the calling-station-id used by the wireless connected device 51 to attach to the wireless communications network and send the request 52. In this example the calling-station-id is the MSISDN. Similarly to the operation of the access control service 9 of the first embodiment described above, the access control service 54 carries out a validation 55 which determines whether or not the calling-station-id used by the wireless connected device 51 is an authorized calling-station-id, that is, a calling-station-id which maps to a wireless connected device authorized to access the network resource 53, and, if the calling-station-id is an authorized calling-station-id, the identity of this associated authorized wireless connected device.

If the access control service 54 determines that the calling-station-id does not map to an authorized device 51, the request to access the network resource 53 is refused 56. Alternatively, if the access control service 54 determines that the calling-station-id does map to an authorized device 31, the access control service 54 sends an instruction 57 to the device 31 to proceed further with the PDP access request.

On receiving the instruction 57 the wireless connected device 51 uses an identification module of the wireless connected device 51 to generate 58 a secure token 59, for example an OTP token, and send to an authorization server 60.

The authorization server 60 checks 61 whether the received secure token 59 is a valid secure token, and if it is a valid secure token, the identity of wireless connected device that it relates to. This check may be carried out in any convenient manner. A number of such check methods are known in the field of secure identity checking and access control.

The authorization server 60 sends a reply back to the access control service 54 indicating whether or not the provided secure token 59 is valid. Further, if the provided secure token 59 is valid, the authorization server 60 also sends the identity of the wireless connected device 51 corresponding to that secure token 59 together with, or as a part of, the reply.

If the reply is a reply 62 indicating that the provided secure token 59 is not valid, the access control service 54 refuses the request to access the network resource 53.

If the reply is a reply 63 indicating that the provided secure token 59 is valid, the access control service 54 checks 64 whether or not the identity of the wireless connected device 51 sent by the authorization server 60 corresponds to the identity of the authorized wireless connected device 51 identified by the mapping by the access control service 54.

If the access control service 54 determines that the identity of the wireless connected device 51 sent by the authorization server 60 does not correspond to the identity of the authorized wireless connected device 51 identified by the mapping, the access control service 54 refuses 65 the request to access the network resource 53. Alternatively, if the access control service 54 determines that the identity of the wireless connected device 31 sent by the authorization server 60 does correspond to the identity of the authorized wireless connected device identified by the mapping, the access control service 54 accepts the request to access the network resource 53, and sends an acceptance message 66 to the wireless connected device 51.

On receiving the acceptance message 66 the wireless connected device 51 sets up 67 a PDP connection 68 to the network resource 59, as permitted by the access control service 54.

Accordingly, the method 50 according to the illustrated third embodiment verifies the identity of a wireless connected device 51 which provides a calling-station-id which is verified by the access control service 54, and also provides a secure identifier which is authenticated by the authorization server 60, by confirming that the verified calling-station-id and the authenticated secure identifier match, that is, are both associated with the same specific device 51. This provides two factor identification of the wireless connected device 51, with the first factor being the calling-station-id used, which is associated with the eSIM profile used by the wireless connected device 51, and the second factor being the secure identifier, which is associated with the identification module of the wireless connected device 51. Further, the method 50 according to the third embodiment only permits access to the network resource 43 by wireless connected devices 51 which have had their identity verified. Accordingly, the present disclosure may provide improved security preventing access by unauthorized devices to the network resource.

In the embodiments described above, requests for access to resources by a wireless device may be refused. In some examples, when a request for access to resources by a wireless device is refused an alert that an unauthorized access request has been made may be generated. Such alerts may be sent to operators or systems supervising and/or controlling operation of the access control system 1.

The embodiments described above relate to systems and methods for verifying the identities of wireless connected devices, and then using the results of the verifications as a basis for controlling access to resources by the wireless connected devices. In other examples the results of the verifications may be used for other purposes.

In FIG. 1, only a single mobile communications network operated by a single Mobile Network Operator (MNO) is shown, for clarity. It will be understood that in practice a large number of different mobile communications networks are available, that are operated by individual MNOs or groups or alliances of MNOs. These different mobile communications networks may have different geographical extents which may be separate, or may partially or completely overlap one another.

It should be understood that the second and third embodiments described above are more specific, and more detailed, examples of the first embodiment. Accordingly, features described with respect to one embodiment may be added to or combined with features of the other embodiments.

The embodiments described above are described as being automatically carried out without human intervention. In other examples some human decision making may be involved.

The above description discusses embodiments of the invention with reference to a single network resource, for clarity. It will be understood that in practice the system and method may be used to control access to a plurality of network resources.

In the described embodiments of the invention the system may be implemented as any form of a computing and/or electronic device.

Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The computer executable instructions may be provided using any computer-readable media that is accessible by computing based device. Computer-readable media may include, for example, computer storage media such as a memory and communications media. Computer storage media, such as a memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media.

Although the access control service and the authorization server are each shown as separate single devices it will be appreciated that either or both may be distributed or located remotely and accessed via a network or other communication link (e.g. using a communication interface). Further, the access control service and the authorization server may be combined in a single device.

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The order of the elements of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this disclosure.

1. A method of verifying an identity of a wireless device, the method comprising:
receiving a calling station identity from a SIM of a wireless device;
receiving a secure identifier derived by a secure element of the wireless device;
comparing the received calling station identity to calling station identities of authorized wireless devices to obtain a corresponding wireless device identity;
confirming whether the secure identifier is authentic and determining a second wireless device identity from the secure identifier;
comparing the first wireless device identity and the second wireless device identity to verify the identity of the wireless device.

2. The method of claim 1, in which the calling station identity and the secure identifier are received together.

3. The method of claim 1, in which the first wireless device identity is determined before confirming whether the secure identifier is authentic and determining a second wireless device identity from the secure identifier, and if the first wireless device identity cannot be determined the confirming whether the secure identifier is authentic and determining a second wireless device identity from the secure identifier is not carried out.

4. The method of claim 1, in which the calling station identity and the secure identifier are received separately, wherein the secure identifier is received in response to a request sent to the wireless device, and the request is sent only after the first wireless device identity has been determined.

5. The method of claim 1, in which the SIM is an eUICC enabled SIM ‘eSIM’.

6. The method of claim 1, in which the calling station identity is a calling station identity of an eSIM profile of the eSIM.

7. The method of claim 1, in which the database contains calling station identities of eSIM profiles and wireless device identities corresponding to the eSIM profiles.

8. The method of claim 1, in which the secure element is a physical element physically attached to the wireless device.

9. The method of claim 1, in which the secure identifier is unique to a specific wireless device.

10. The method of claim 1, in which the calling station identity is a Mobile Subscriber Integrated Services Digital Network Number ‘MSISDN’, or an International Mobile Subscriber Identity ‘IMSI’.

11. A method of controlling access to a resource, the method comprising:
verifying the identity of a wireless device using the method of claim 1; and
if the identity of the wireless device is verified, allowing the wireless device to access a resource; or
if the identity of the wireless device is not verified, not allowing the wireless device to access the resource.

12. The method of claim 11, in which the database contains calling station identities of wireless devices authorized to access the resource and corresponding wireless device identities.

13. The method of claim 11, in which confirming whether the secure identifier is authentic comprises determining whether the secure identifier is associated with a wireless device authorized to access the resource.

14. A system for verifying the identity of a wireless device, the system comprising:
means arranged to receive a calling station identity from a SIM of a wireless device;
means arranged to receive a secure identifier derived by a secure element of the wireless device;
means arranged to compare the received calling station identity to calling station identities of authorized wireless devices to obtain a corresponding wireless device identity;
means arranged to confirm whether the secure identifier is authentic and determining a second wireless device identity from the secure identifier;
means arranged to compare the first wireless device identity and the second wireless device identity to verify the identity of the wireless device.

15. The system of claim 14, in which the calling station identity and the secure identifier are received together.

16. The system of claim 14, in which the system is arranged to determine the first wireless device identity before confirming whether the secure identifier is authentic and determining a second wireless device identity from the secure identifier, and to not carry out the determining a second wireless device identity from the secure identifier if the first wireless device identity cannot be determined.

17. The system of claim 14, in which the calling station identity and the secure identifier are received separately, wherein the secure identifier is received in response to a request sent to the wireless device, and the request is sent only after the first wireless device identity has been determined.

18-20. (canceled)

21. The system of claim 14, in which the secure element is a physical element physically attached to the wireless device.

22-23. (canceled)

24. A system for controlling access to a resource, the system comprising:
a system arranged to verifying the identity of a wireless device according to claim 14; and
further comprising means arranged to:
if the identity of the wireless device is verified, allow the wireless device to access a resource; or
if the identity of the wireless device is not verified, not allowing the wireless device to access the resource.

25-26. (canceled)

27. A computer program comprising computer readable instructions which, when executed by a processor of a computer cause the computer to carry out the method of claim 1.
